(19) United States
(12) Patent Application Publication
(10) Pub. No.: US 2016/0076624 A1
(43) Pub. Date: Mar. 17, 2016

(54) MOTOR WITH SPEED REDUCER

(71) Applicant: NABTESCO CORPORATION, Tokyo (JP)

(72) Inventors: Masato UCHIHARA, Mie (JP); Kohei NAGAHARA, Mie (JP)

(21) Appl. No.: 14/855,816

(22) Filed: Sep. 16, 2015

(30) Foreign Application Priority Data
Sep. 17, 2014 (JP) 2014-188999

(51) Int. Cl. F16H 1/32; H02K 7/116

(52) U.S. Cl. CPC F16H 1/32; H02K 7/116

(57) ABSTRACT

A motor with speed reducer is provided with a motor including a motor shaft and an input shaft shrink-fitted to a tip of the motor shaft, and a speed reducer including an input gear to be driven by the input shaft and configured to obtain output rotation decelerated at a predetermined speed reduction ratio from input rotation of the input gear.

### TECHNICAL FIELD

The present invention relates to a motor with speed reducer.

### BACKGROUND ART

Conventionally, a speed reducer for obtaining output rotation decelerated at a predetermined speed reduction ratio from input rotation has been known. As such a speed reducer, a speed reducer 90 with an eccentric body 92 which rockingly rotates with the rotation of a driven gear 91, an external gear 93 which rockingly rotates with the rocking rotation of the eccentric body 92 and a carrier body 94 which rotates with the rocking rotation of the external gear 93 as shown in FIG. 3 is described in patent literature 1 (Japanese Unexamined Patent Publication No. 2003-278848). The speed reducer 90 of patent literature 1 further includes an input shaft 95 provided to penetrate through a central part of the speed reducer 90 in an axial direction. A pinion 96 provided on one end of the input shaft 95 is meshed with the driven gear 91. The input shaft 95 is formed with a hollow portion 97 open on the other end side of the input shaft 95, and an output shaft of a motor is inserted into this hollow portion 97. In this way, a drive force is transmitted from the output shaft of the motor to the driven gear 91 via the input shaft 95 and the carrier body 94 is rotated by output rotation decelerated at a predetermined speed reduction ratio from the rotation of the driven gear 91.

To sufficiently insert the output shaft of the motor into the hollow portion 97 of the input shaft 95 in the speed reducer 90 of patent literature 1, a projection length of the output shaft in the motor needs to be set relatively long. In such a case, the motor mounted with the speed reducer 90 of patent literature 1 is possibly enlarged in the axial direction.

Contrary to this, if the projection length of the output shaft in the motor is set relatively short, a joining part of the input shaft 95 and the output shaft becomes short. This weakens a joining force of the input shaft 95 and the output shaft. In such a case, a permissible torque possibly becomes small in the motor mounted with the speed reducer 90 of patent literature 1.

### SUMMARY OF INVENTION

The present invention was developed in view of the above point and aims to provide a motor with speed reducer capable of realizing miniaturization while suppressing a reduction in permissible torque.

A motor with speed reducer according to one aspect of the present invention is provided with a motor including a motor shaft and an input shaft shrink-fitted to a tip of the motor shaft, and a speed reducer including an input gear to be driven by the input shaft and configured to obtain output rotation decelerated at a predetermined speed reduction ratio from the rotation of the input gear.

### BRIEF DESCRIPTION OF DRAWINGS

FIG. 1 is a sectional view of an essential part showing a schematic configuration of a motor with speed reducer according to an embodiment,

FIG. 2 is a sectional view of an essential part showing a schematic configuration of a modification of the motor with speed reducer according to the embodiment, and

FIG. 3 is a sectional view of an essential part showing a schematic configuration of a speed reducer according to patent literature 1.

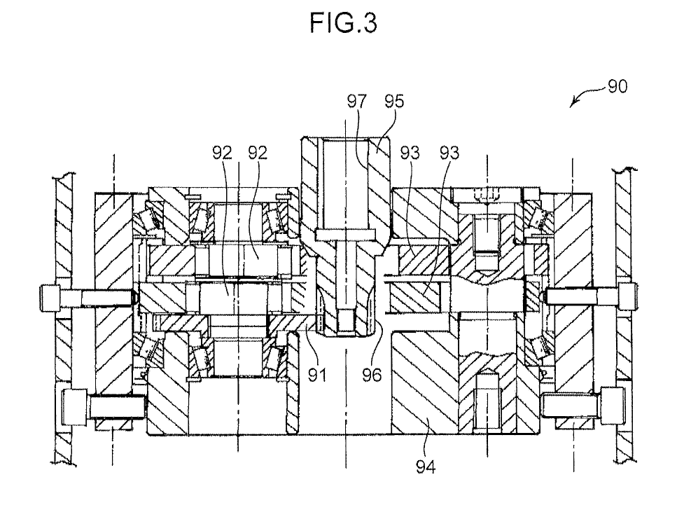

### DESCRIPTION OF EMBODIMENT

Hereinafter, one embodiment of the present invention is described with reference to the drawings. Note that the following embodiment is a specific example of the present invention and not of the nature to limit the technical scope of the present invention.

Each drawing to be referred to below shows only main members in a simplified manner out of constituent members of a motor with speed reducer X1 according to this embodiment and shows only a cross-section of an essential part. The motor with speed reducer X1 according to this embodiment can include any arbitrary constituent member not shown in each drawing to be referred to in this specification.

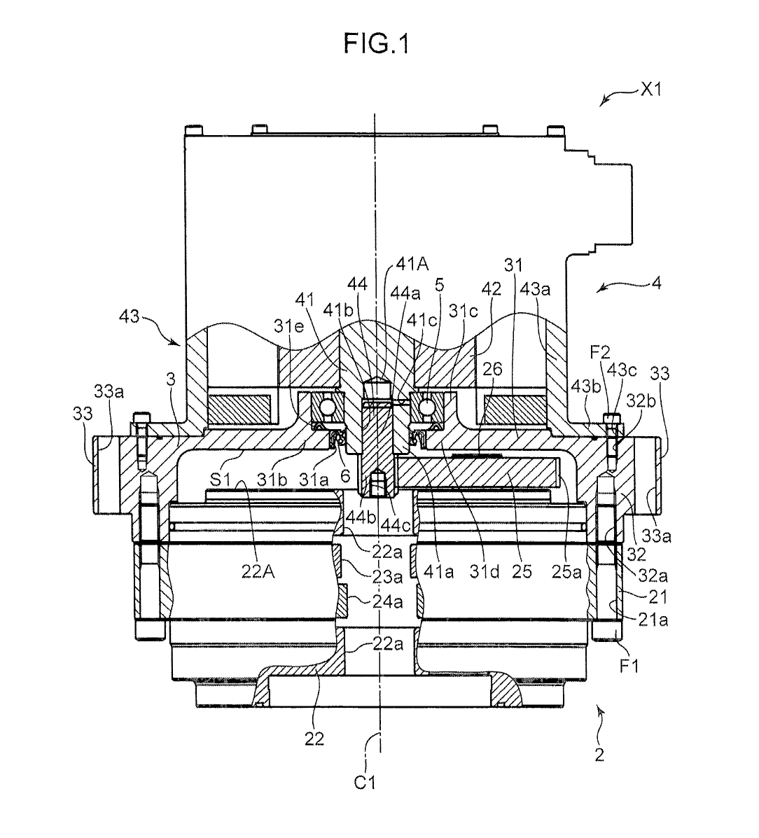

As shown in FIG. 1, the motor with speed reducer X1 includes a motor 4 and a speed reducer 2 capable of obtaining output rotation decelerated at a predetermined speed reduction ratio by a drive force from the motor 4.

The motor 4 includes a motor shaft 41, a rotor 42, an input shaft 44, a housing 43, a partitioning member 3, a bearing 5 and a seal member 6. The motor shaft 41 is a rotary shaft of the motor 4. The rotor 42 rotates the motor shaft 41. The input shaft 44 transmits a drive force corresponding to the rotation of the motor shaft 41 to the speed reducer 2. The housing 43 forms a space for housing the motor shaft 41 and the rotor 42. The partitioning member 3 defines an end part of the speed reducer 2 on the side of the motor 4. The bearing 5 bears the motor shaft 41. The seal member 6 prevents the intrusion of oil and the like into the interior of the motor 4.

The rotor 42 is mounted on the motor shaft 41. The rotor 42 is arranged inside an unillustrated stator. The motor shaft 41 extends in a direction of an axis C1 and rotates about the axis C1 as an axial center with the rotation of the rotor 42.

A tip 41a of the motor shaft 41 projects more toward the speed reducer 2 than the rotor 42 in the direction of the axis C1. The tip 41a has a recess 41b. Specifically, a part of an end surface of the tip 41a located on the side of the speed reducer 2 in the direction of the axis C1 is recessed toward the rotor 42 along the direction of the axis C1. The recess 41b includes an inner surface of the tip 41a formed by recessing the part of the end surface of the tip 41a. This inner surface includes a bottom surface 41A located on the side of the rotor 42 in the direction of the axis C1.

The tip 41a of the motor shaft 41 is formed with a communication hole 41c allowing communication between a space in the recess 41b and the outside of the motor shaft 41. The communication hole 41c is formed to penetrate through the recess 41b and the outer peripheral surface of the motor shaft 41 along a radial direction of the motor shaft 41.

The input shaft 44 is shrink-fitted to the tip 41a of the motor shaft 41. Specifically, the input shaft 44 is inserted into the recess 41b on the tip 41a along the direction of the axis C1 and fixed to the recess 41b by shrink-fitting. An axial center of the input shaft 44 is located coaxially with the axis C1 as the axial center of the motor shaft 41.

The input shaft 44 includes an inserting portion 44a inserted into the recess 41b and a transmitting portion 44b for transmitting a drive force from the motor shaft 41 to input gears 25 of the speed reducer 2 to be described later.

The inserting portion 44a has an outer diameter substantially equal to an inner diameter of the recess 41b. A clearance is formed between the inserting portion 44a and the bottom surface 41A of the recess 41b. This clearance is connected to the communication hole 41c. Note that a surface of the inserting portion 44a in contact with the recess 41b may be formed with minute projections and recesses extending in the axial direction, for example, by knurling.

The transmitting portion 44b is located closer to the speed reducer 2 than the inserting portion 44a in the direction of the axis C1. The transmitting portion 44b has an outer diameter larger than the inner diameter of the recess 41b. A plurality of tooth portions extending in the direction of the axis C1 are formed side by side in a circumferential direction on the outer peripheral surface of the transmitting portion 44b. These tooth portions are meshed with external teeth 25a of the input gears 25 to be described later, whereby a drive force is transmitted from the motor shaft 41 to the input gears 25.

The transmitting portion 44b is formed with a positioning hole 44c for adjusting relative positions of the transmitting portion 44b and the input gears 25 of the speed reducer 2. Specifically, a part of an end surface of the transmitting portion 44b on the side of the speed reducer 2 in the axis C1 is recessed toward the inserting portion 44a along the direction of the axis C1 and this recessed area serves as the positioning hole 44c. A center axis of the positioning hole 44c is located concentrically with the axis C1 as the axial center of the motor shaft 41.

The inserting portion 44a of the input shaft 44 is inserted into the recess 41b in a state where the motor shaft 41 is expanded to extend an inner diameter of the recess 41b by being heated. The insertion is stopped at a position where the transmitting portion 44b comes into contact with the end surface of the tip 41a in the direction of the axis C1. In this insertion process, gas present in the recess 41b is released to the outside of the motor shaft 41 through the communication hole 41c. Then, the motor shaft 41 is cooled and the inner diameter of the recess 41b returns to an initial one, whereby the recess 41b and the inserting portion 44a are fixed. In this way, the input shaft 44 is shrink-fitted to the tip 41a of the motor shaft 41.

The housing 43 includes a tubular housing main body 43a closed on a side opposite to the speed reducer 2 in the direction of the axis C1 and a flange-like extending portion 43b protruding radially outwardly of the housing main body 43a from the housing main body 43a.

A part of the motor shaft 41, the rotor 42, the unillustrated stator and the like are housed in the housing main body 43a. The housing main body 43a is open on the side of the speed reducer 2 in the direction of the axis C1 and the transmitting portion 44b of the input shaft 44 is projecting further toward the speed reducer 2 than this opening in the direction of the axis C1.

The extending portion 43b extends radially outwardly of the housing main body 43a from an end part of the housing main body 43a on the side of the speed reducer 2. The extending portion 43b is in the form of a flat plate perpendicular to the axis C1 and formed into a circular ring shape to circumferentially surround the housing main body 43a.

The extending portion 43b is formed with a plurality of insertion holes 43c. The respective insertion holes 43c penetrate through the extending portion 43b in the direction of the axis C1 and are provided at predetermined intervals in the circumferential direction.

The partitioning member 3 includes a disc-like partitioning portion 31 partitioning between the interior of the motor 4 and that of the speed reducer 2, a circular ring-shaped leg portion 32 supporting the outer edge of the partitioning portion 31 and a flange-like mounting portion 33 projecting radially outward from the leg portion 32.

The partitioning portion 31 is arranged to face an end surface 22A of a later-described carrier 22 of the speed reducer 2. The later-described input gears 25 of the speed reducer 2 are located between the partitioning portion 31 and the end surface 22A of the carrier 22. Further, the partitioning portion 31 closes the opening in the housing main body 43a from the side of the speed reducer 2. The partitioning portion 31 is formed with a through hole 31a penetrating through a central part of the partitioning portion 31 in the direction of the axis C1.

Specifically, the partitioning portion 31 includes a flat and disc-like first part 31b and a second part 31c extending toward the rotor 42 along the direction of the axis C1 from a radially intermediate position of the first part 31b. The second part 31c is formed into a circular ring shape concentric with the axis C1. A space is formed between the second part 31c and the housing main body 43a in a radial direction. A coil and the like of the stator are, for example, arranged in this space.

In this embodiment, the inner peripheral surface of the second part 31c and that of the first part 31b located closer to the axis C1 than the second part 31c are included in a peripheral edge portion 31d defining the through hole 31a. Specifically, the through hole 31a is a stepped hole surrounded by the inner peripheral surface of the second part 31c and that of the first part 31b located closer to the axis C1 than the second part 31c.

A washer 31e is provided on a surface of a part of the first part 31b located closer to the axis C1 than the second part 31c on the side of the rotor 42. The washer 31e is formed into a circular ring shape to surround the tip 41a of the motor shaft 41 and raised in a corrugated manner. A height of a highest part of the washer 31e from a surface of the first part 31b on the side of the rotor 42 as a reference surface is set lower than a height of a highest part of the second part 31c.

The bearing 5 is mounted in the peripheral edge portion 31d. Specifically, the bearing 5 is formed into a circular ring shape and the outer peripheral surface thereof is mounted on the inner peripheral surface of the second part 31c out of the peripheral edge portion 31d. The bearing 5 is in contact with the washer 31e in the direction of the axis C1. In this way, the rattling of the bearing 5 is suppressed by the washer 31e.

Further, the seal member 6 is mounted in the peripheral edge portion 31d. The seal member 6 is located closer to the speed reducer 2 than the bearing 5 in the direction of the axis C1. Specifically, the seal member 6 is formed into a circular ring shape and the outer peripheral surface thereof is mounted on the inner peripheral surface of the first part 31b out of the peripheral edge portion 31d.

Here, the tip 41a of the motor shaft 41 to which the input shaft 44 is shrink-fitted is inserted into the through hole 31a. Specifically, the tip 41a of the motor shaft 41 to which the input shaft 44 is shrink-fitted is inserted into the bearing 5 and the seal member 6 along the direction of the axis C1. In this way, the tip 41a of the motor shaft 41 is arranged in the through hole 31a and the transmitting portion 44b of the input shaft 44 is arranged closer to the speed reducer 2 than the first part 31b of the partitioning portion 31 in the direction of the axis C1. The tip 41a of the motor shaft 41 arranged in the through hole 31a is rotatably supported on the bearing 5 by being held in contact with the inner peripheral surface of the bearing 5. Further, the intrusion of oil and the like into the interior of the motor 4 from the interior of the speed reducer 2 via the through hole 31a is prevented by closing a clearance between the tip 41a of the motor shaft 41 arranged in the through hole 31a and the peripheral edge portion 31d by the seal member 6.

Note that although a part of the tip 41a is located closer to the speed reducer 2 than the first part 31b of the partitioning portion 31 in the direction of the axis C1 in this embodiment, there is no limitation to this. The tip 41a may be entirely located closer to the rotor 42 than a surface of the first part 31b of the partitioning portion 31 on the side of the speed reducer 2 in the direction of the axis C1.

The leg portion 32 is connected to the outer edge of the partitioning portion 31 and extends toward the speed reducer 2 along the direction of the axis C1 from the outer edge of the partitioning portion 31. The extending portion 43b of the housing 43 is in contact with a surface of the leg portion 32 on one side in the direction of the axis C1. Further, an outer cylinder 21 of the speed reducer 2 to be described later is in contact with a surface of the leg portion 32 on the other side in the direction of the axis C1. In this state, a housing space S1 surrounded by the first part 31b of the partitioning portion 31, the leg portion 32 and the end surface 22A of the carrier 22 is formed and the input gears 25 are located in this housing space S1.

The leg portion 32 is formed with a plurality of first fastening holes 32a open on a surface on the side of the speed reducer 2. The first fastening holes 32a are provided at predetermined intervals in the circumferential direction.

Further, the leg portion 32 is formed with a plurality of second fastening holes 32b open on a surface opposite to the one on which the first fastening holes 32a are open. The second fastening holes 32b are provided at predetermined intervals in the circumferential direction, and arranged at positions corresponding to the insertion holes 43c formed on the extending portion 43b of the housing 43. By threadably engaging screw-like second fastening members F2 inserted into the insertion holes 43c with the leg portion 32 in the second fastening holes 32b, the housing 43 and the partitioning member 3 are fastened to each other.

The mounting portion 33 is formed with a plurality of mounting holes 33a penetrating through the mounting portion 33 in the direction of the axis C1. A mating member of the motor with speed reducer X1 is mounted on the mounting portion 33 via the mounting holes 33a.

The speed reducer 2 is an eccentric rocking gear device. The speed reducer 2 includes the outer cylinder 21 as a fixed-side member, the carrier 22 as a rotating-side member, oscillation gears 23, 24 for rotating the carrier 22, crankshafts 26 for rockingly rotating the oscillation gears 23, 24 and the input gears 25 mounted on the crankshafts 26.

The outer cylinder 21 is so arranged that a center axis thereof is located concentrically with the axis C1 as the axial center of the motor shaft 41.

The outer cylinder 21 is formed with a plurality of insertion holes 21a. The respective insertion holes 21a penetrate through the outer cylinder 21 in the direction of the axis C1 and are arranged at positions corresponding to the first fastening holes 32a formed on the leg portion 32 of the partitioning member 3. Screw-like first fastening members F1 inserted into the insertion holes 21a are threadably engaged with the leg portion 32 in the first fastening holes 32a, whereby the outer cylinder 21 and the partitioning member 3 are fastened to each other. In this way, the speed reducer 2 is mounted on the motor 4.

The carrier 22 is arranged in the outer cylinder 21. The carrier 22 is supported to sandwich the oscillation gears 23, 24 in the direction of the axis C1. The oscillation gears 23, 24 have an outer diameter slightly smaller than an inner diameter of the outer cylinder 21. The rocking gear 23, 24 includes a plurality of external teeth on the outer peripheral surface thereof and is configured to be rockingly rotatable by meshing the plurality of external teeth with a plurality of internal teeth provided on the inner peripheral surface of the outer cylinder 21. In this embodiment, the carrier 22 is formed with a through hole 22a penetrating through a central part of the carrier 22 in the direction of the axis C1 and the rocking gear 23, 24 is formed with a through hole 23a, 24a communicating with the through hole 22a. In this way, a central part of the entire speed reducer 2 is hollow in the direction of the axis C1.

In this embodiment, a tip part of the transmitting portion 44b is housed in the through hole 22a. This can suppress the enlargement of the motor with speed reducer X1 in the direction of the axis C1. Further, in this embodiment, the size of the through hole 22a is so set that the motor shaft 41 cannot pass through the through hole 22a. Specifically, an inner diameter of the through hole 22a is set slightly smaller than an outer diameter of the motor shaft 41. This can suppress the radial enlargement of the motor with speed reducer X1.

The crankshaft 26 includes two eccentric portions and is so configured that the oscillation gears 23, 24 rockingly rotate according to the rotation of the respective eccentric portions. A plurality of the crankshafts 26 are provided at predetermined intervals in the circumferential direction to surround the axis C1. An end part of each crankshaft 26 projects further toward the motor 4 than the end surface 22A forming the housing space S1 out of end surfaces of the carrier 22 in the axial direction.

The input gear 25 is mounted on an end part of each crankshaft 26 projecting further toward the motor 4 than the end surface 22A of the carrier 22. The input gear 25 includes a plurality of external teeth 25a on the outer peripheral surface thereof. Some of the plurality of external teeth 25a are positioned to overlap the through holes 22a, 23a and 24a in the direction of the axis C1 and meshed with the tooth portions formed on the outer peripheral surface of the transmitting portion 44b in the input shaft 44.

In the motor with speed reducer X1, a drive force is transmitted to the input gears 25 from the transmitting portion 44b of the input shaft 44 according to the rotation of the motor shaft 41. This causes the input gears 25 to rotate at a predetermined number of revolutions and, associated with this, each eccentric portion of the crankshaft 26 rockingly rotates. According to the rocking rotation of each eccentric portion of the crankshaft 26, the oscillation gears 23, 24 rockingly rotate so that the external teeth thereof are meshed with the internal teeth of the outer cylinder 21. In this way, the carrier 22 rotates at a number of revolutions decelerated at a predetermined speed reduction ratio from the number of revolutions of the input gears 25. Specifically, the carrier 22 serves as an output portion which rotates at a number of revolutions corresponding to a number of revolutions of the motor shaft 41.

Note that although the speed reducer 2 is an eccentric rocking gear device in this embodiment, there is no limitation to this and any speed reducer may be adopted provided that it can obtain output rotation decelerated at a predetermined speed reduction ratio from the rotation of the input gears 25. For example, the speed reducer 2 may be a wave gear device.

As described above, since the input shaft 44 is shrink-fitted to the tip 41a of the motor shaft 41 in the motor with speed reducer Xl, the input shaft 44 and the motor shaft 41 can be strongly joined even if a length of the inserting portion 44a as a joining part of the input shaft 44 to the motor shaft 41 is short. Thus, a dimension of the motor with speed reducer X1 in the direction of the axis C1 can be reduced and a reduction in permissible torque of the motor with speed reducer X1 can be suppressed.

Particularly, since the input shaft 44 is shrink-fitted to the recess 41b of the tip 41a in the motor shaft 41 in this embodiment, the tip 41a needs not largely project toward the speed reducer 2 than the partitioning portion 31 in the direction of the axis C1. Thus, the dimension of the motor with speed reducer X1 in the direction of the axis C1 can be more reduced.

Furthermore, in the motor with speed reducer X1, gas present in the recess 41b is released to the outside of the motor shaft 41 through the communication hole 41c in the process of inserting the input shaft 44 into the recess 41b in shrink-fitting the input shaft 44 to the motor shaft 41. Thus, the input shaft 44 can be sufficiently inserted into the recess 41b and the input shaft 44 and the motor shaft 41 can be more strongly joined.

Particularly, in this embodiment, the clearance formed between the inserting portion 44a and the bottom surface of the recess 41b is connected to the communication hole 41c in a state where the inserting portion 44a is inserted into the recess 41b and the insertion is stopped at the position where the transmitting portion 44b comes into contact with the surface of the tip 41a on which the recess 41b is open. Thus, in the process of inserting the input shaft 44 into the recess 41b, the gas present in the recess 41b can be reliably released to the outside of the motor shaft 41.

Further, since the partitioning member 3 partitioning between the motor 4 and the speed reducer 2 also functions as a mounting member for the bearing 5 and the seal member 6 in the motor with speed reducer X1, the number of parts can be reduced and the size of the motor with speed reducer X1 can be reduced as compared with the case where the partitioning member 3 and the mounting member are configured as separate members.

Further, although the input gears 25 are located at an outer side of the end surface 22A of the carrier 22 in the motor with speed reducer X1, the input gears 25 are housed in the housing space S1 by providing the partitioning member 3, wherefore the input gears 25 can be protected.

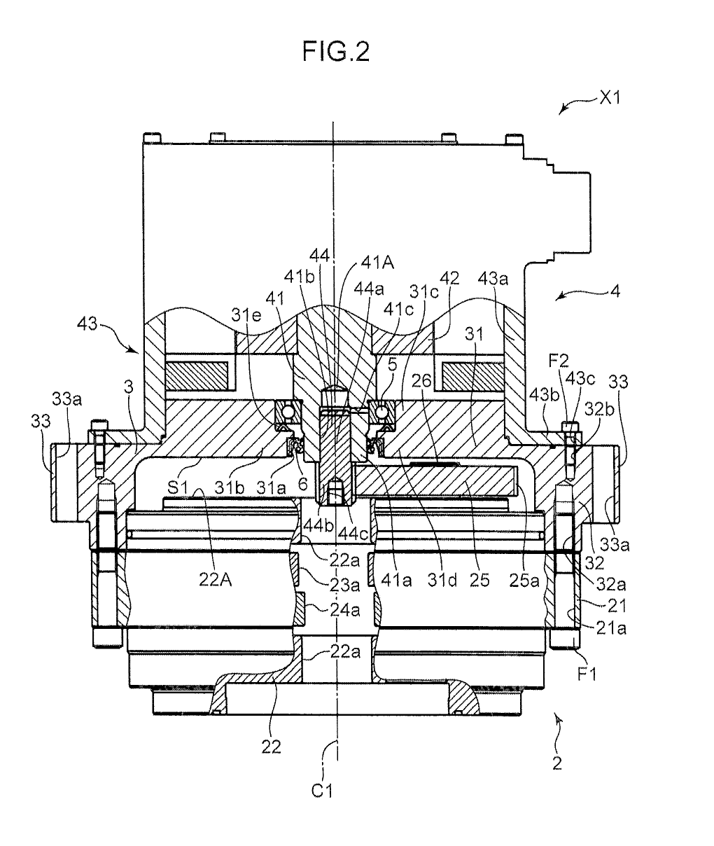

Note though although the space is formed between the second part 31c of the partitioning portion 31 and the housing main body 43a in the radial direction in this embodiment, there is no limitation to this and this space may not be formed as in a modification shown in FIG. 2.

In the modification shown in FIG. 2, a thickness of a second part 31c in the radial direction is set larger than that of the second part 31c of the embodiment shown in FIG. 1 in the radial direction. The outer peripheral surface of the second part 31c is in contact with the inner peripheral surface of a housing main body 43a. Further, a part of the inner peripheral surface of a first part 31b located on the side of a speed reducer 2 in the direction of the axis C1 is recessed outwardly in the radial direction and a seal member 6 is mounted on this recessed surface. As just described, in this modification, the housing main body 43a is arranged to be fitted to the second part 31c and a peripheral edge portion 31d surrounding a through hole 31a is formed to project radially inwardly in an intermediate part in the direction of the axis C1.

Further, although the housing 43 includes the extending portion 43b and the extending portion 43b and the leg portion 32 of the partitioning member 3 are fastened by the second fastening members F2 in this embodiment, there is no limitation to this. For example, the speed reducer 2 may be mounted on the motor 4 by fastening the partitioning portion 31 and the stator in the motor 4. In this case, the partitioning portion 31 is formed with a through hole penetrating in the direction of the axis C1 and a fastening member inserted into this through hole from the side of the housing space S1 is threadably engaged with a fastening hole formed on the stator. According to such a configuration, the extending portion 43b is unnecessary in the housing 43.

The embodiment and the modification described above should be considered to be illustrative in all aspects and not to be restrictive. The scope of the present invention is defined not by the description of the embodiment and the modification, but by the appended claims and includes all changes within the meaning and scope of the appended claims and equivalents thereof.

The above embodiment is outlined below.

The above motor with speed reducer is provided with a motor including a motor shaft and an input shaft shrink-fitted to a tip of the motor shaft, and a speed reducer including an input gear to be driven by the input shaft and configured to obtain output rotation decelerated at a predetermined speed reduction ratio from the rotation of the input gear.

Since the input shaft is shrink-fitted to the tip of the motor shaft in the above motor with speed reducer, the input shaft and the motor shaft can be strongly joined even if a length of a joining part of the input shaft and the motor shaft is short. Thus, a dimension of the motor with speed reducer in an axial direction of the input shaft and the motor shaft can be reduced and a reduction in permissible torque of the motor with speed reducer can be suppressed.

Further, the motor shaft preferably includes a recess into which the input shaft is to be inserted and a communication hole which allows communication between the interior of the recess and the outside of the motor shaft.

In the above motor with speed reducer, gas present in the recess is released to the outside of the motor shaft though the communication hole in the process of inserting the input shaft into the recess in shrink-fitting the input shaft to the motor shaft. Thus, the input shaft can be sufficiently inserted into the recess and the input shaft and the motor shaft can be more strongly joined.

The motor preferably further includes a partitioning member including a through hole into which the input shaft and the motor shaft are to be inserted and defining an end part of the speed reducer on the side of the motor, a bearing mounted on a peripheral edge portion of the partitioning member surrounding the through hole and configured to bear the motor shaft, and a seal member mounted on the peripheral edge portion of the partitioning member and located closer to the speed reducer than the bearing.

Since the partitioning member partitioning between the interior of the motor and that of the speed reducer also functions as a mounting member for the bearing and the seal member in the above motor with speed reducer, the number of parts can be reduced and the size of the motor with speed reducer can be reduced as compared with the case where the partitioning member and the mounting member are configured as separate members.

Further, the partitioning member is preferably formed to define a housing space for housing the input gear.

Since the input gear is housed in the housing space by providing the partitioning member in the above motor with speed reducer, the input gear can be protected even if the input gear is exposed to the outside of the speed reducer.

This application is based on Japanese Patent application No. 2014-188999 filed in Japan Patent Office on Sep. 17, 2014, the contents of which are hereby incorporated by reference.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

1. A motor with speed reducer, comprising:
a motor including a motor shaft and an input shaft shrink-fitted to a tip of the motor shaft; and
a speed reducer including an input gear to be driven by the input shaft and configured to obtain output rotation decelerated at a predetermined speed reduction ratio from input rotation of the input gear.

2. A motor with speed reducer according to claim 1, wherein the motor shaft includes a recess into which the input shaft is to be inserted and a communication hole which allows communication between the interior of the recess and the outside of the motor shaft.

3. A motor with speed reducer according to claim 1, wherein the motor further includes a partitioning member including a through hole into which the input shaft and the motor shaft are to be inserted and defining an end part of the speed reducer on the side of the motor, a bearing mounted on a peripheral edge portion of the partitioning member surrounding the through hole and configured to bear the motor shaft, and a seal member mounted on the peripheral edge portion of the partitioning member and located closer to the speed reducer than the bearing.

4. A motor with speed reducer according to claim 2, wherein the motor further includes a partitioning member including a through hole into which the input shaft and the motor shaft are to be inserted and defining an end part of the speed reducer on the side of the motor, a bearing mounted on a peripheral edge portion of the partitioning member surrounding the through hole and configured to bear the motor shaft, and a seal member mounted on the peripheral edge portion of the partitioning member and located closer to the speed reducer than the bearing.

5. A motor with speed reducer according to claim 3, wherein the partitioning member is formed to define a housing space for housing the input gear.
